(19) United States
(12) Patent Application Publication
(10) Pub. No.: US 2014/0230770 A1
(43) Pub. Date: Aug. 21, 2014

(54) TRANSIENT PLASMA ELECTRODE FOR RADICAL GENERATION

(71) Applicants: Andras Kuthi, Thousand Oaks, CA (US); Martin A. Gundersen, San Gabriel, CA (US); Yung-Hsu Lin, Los Angeles, CA (US); Daniel R. Singleton, El Segundo, CA (US)

(72) Inventors: Andras Kuthi, Thousand Oaks, CA (US); Martin A. Gundersen, San Gabriel, CA (US); Yung-Hsu Lin, Los Angeles, CA (US); Daniel R. Singleton, El Segundo, CA (US)

(73) Assignee: UNIVERSITY OF SOUTHERN CALIFORNIA, Los Angeles, CA (US)

(21) Appl. No.: 14/185,722

(22) Filed: Feb. 20, 2014

Related U.S. Application Data
(60) Provisional application No. 61/767,044, filed on Feb. 20, 2013.

(51) Int. Cl. F02P 9/00

(52) U.S. Cl. CPC F02P 9/007
USPC 123/143 A

(57) ABSTRACT

A transient plasma electrode apparatus may include an elongated electrode having a first and a second end. The first end may connect to a source of high voltage pulses. An insulation jacket may surround a portion of the electrode. An electric-field enhancing protrusion may be at the second end of the elongated electrode. The protrusion may cause an electric field when a high voltage is applied between the elongated electrode and a metallic wall of a combustion chamber in which the electrode is placed. The electric field may be greater at the second end as compared to along the length of the electrode.

### CROSS-REFERENCE TO RELATED APPLICATION

This application is based upon and claims priority to U.S. provisional patent application 61/767,044, entitled “TRANSIENT PLASMA ELECTRODE FOR RADICAL GENERATION,” filed Feb. 20, 2013, attorney docket number 028080-0835. The entire content of this application is incorporated herein by reference.

### BACKGROUND

1. Technical Field

This disclosure relates to transient plasma ignition of internal combustion engines.

2. Description of Related Art

Automotive internal combustion engines are under strict control by emission legislation due to growing concerns about their environmental impact, and the regulations are becoming more challenging for industry to meet.

Transient plasma ignition, involving short ignition pulses (typically 10-50 ns), can improve engine performance and reduce emissions for a wide range of combustion-driven engines relative to conventional spark ignition. The beneficial effects of radical chemical species generated by transient plasmas are expected to be applicable to compression ignition or diesel engines as well.

However, generating transient plasma at the high pressures inside a combustion chamber of high compression ratio internal combustion engines, such as diesel engines, can be difficult to do. It can be difficult because of the high combustion chamber pressure at compression ratios near 20:1. High electric fields for transient plasma generation may be generated by a high voltage electrode introduced into the cylinder through the port normally used for glow-plugs. However, a small diameter channel in the engine head associated with the glow-plug, such as about 6 mm in diameter, can present a challenge for insulation of the high voltage.

### SUMMARY

A transient plasma electrode apparatus may include an elongated electrode having a first and a second end. The first end may connect to a source of high voltage pulses. An insulation jacket may surround a portion of the electrode. An electric-field enhancing protrusion may be at the second end of the elongated electrode. The protrusion may cause an electric field when a high voltage is applied between the elongated electrode and a metallic wall of a combustion chamber in which the electrode is placed. The electric field may be greater at the second end as compared to along the length of the electrode.

The electric-field enhancing protrusion may include a disc having a perimeter that forms a sharp edge.

The electric-field enhancing protrusion may include one or more spokes.

The insulation jacket may have external threads, may be made of a ceramic material, and/or may have ribs.

The transient plasma electrode apparatus may include a second insulation jacket.

The transient plasma electrode apparatus may be inserted into a cylinder chamber of an engine having a chamber diameter. The elongated electrode may be cylindrical with an electrode diameter of between 0.2-0.6 or 0.33-0.4 times the cylinder diameter. The elongated electrode may have a diameter of between 1.2-3.6 mm or 2-2.4 mm. The elongated electrode may have a length of between 1-5 or 1.5-3 inches.

The first end of the elongated electrode may include an indented portion that attaches to a wire.

A high compression engine may include a metallic, cylindrical combustion chamber; a piston within the cylindrical combustion chamber; and an elongated electrode having an end protruding within the cylindrical combustion chamber. The elongated electrode may not have a ground portion affixed to its end. There may be arcing between the elongated electrode and the cylindrical combustion chamber upon application of high voltage potential between the elongated electrode and cylindrical combustion chamber.

A high compression engine may include a cylindrical combustion chamber; a piston within the cylindrical combustion chamber; and an elongated electrode protruding within the cylindrical combustion chamber. The engine may operate with a compression ratio within the cylindrical combustion chamber that exceeds 16.

These, as well as other components, steps, features, objects, benefits, and advantages, will now become clear from a review of the following detailed description of illustrative embodiments, the accompanying drawings, and the claims.

### BRIEF DESCRIPTION OF DRAWINGS

The drawings are of illustrative embodiments. They do not illustrate all embodiments. Other embodiments may be used in addition or instead. Details that may be apparent or unnecessary may be omitted to save space or for more effective illustration. Some embodiments may be practiced with additional components or steps and/or without all of the components or steps that are illustrated. When the same numeral appears in different drawings, it refers to the same or like components or steps.

FIG. 1 illustrates an example of a transient plasma electrode apparatus.

FIGS. 2A and 2B illustrate an enlarged front-facing and side view, respectively, of a metallic disc that is part of the transient plasma electrode apparatus illustrated in FIG. 1.

FIG. 3 illustrates an example of the disc that is part of the transient plasma electrode apparatus illustrated in FIG. 1 surrounded by a cylinder chamber of an engine.

FIG. 4 is a graph showing a relationship between the radius of the metallic disc (anode) shown in FIG. 1 and an electric field at its surface.

FIG. 5 illustrates an example of a metallic disc with radially-extending sharp tips that may be used in lieu of the metallic disc illustrated in FIG. 1.

FIG. 6 illustrates an example of a metallic disc with radially-extending sharp wire tips that may be used in lieu of the metallic disc illustrated in FIG. 1.

FIG. 7 illustrates the transient plasma electrode apparatus illustrated in FIG. 1 positioned within an example of a high compression engine.

FIG. 8 illustrates another example of a transient plasma electrode apparatus.

### DETAILED DESCRIPTION OF ILLUSTRATIVE EMBODIMENTS

Illustrative embodiments are now described. Other embodiments may be used in addition or instead. Details that may be apparent or unnecessary may be omitted to save space or for a more effective presentation. Some embodiments may be practiced with additional components or steps and/or without all of the components or steps that are described.

A high-voltage electrode may control the electric field along a channel and may utilize the insulation properties of compressed air while enhancing the electric field at the electrode end inside the combustion chamber.

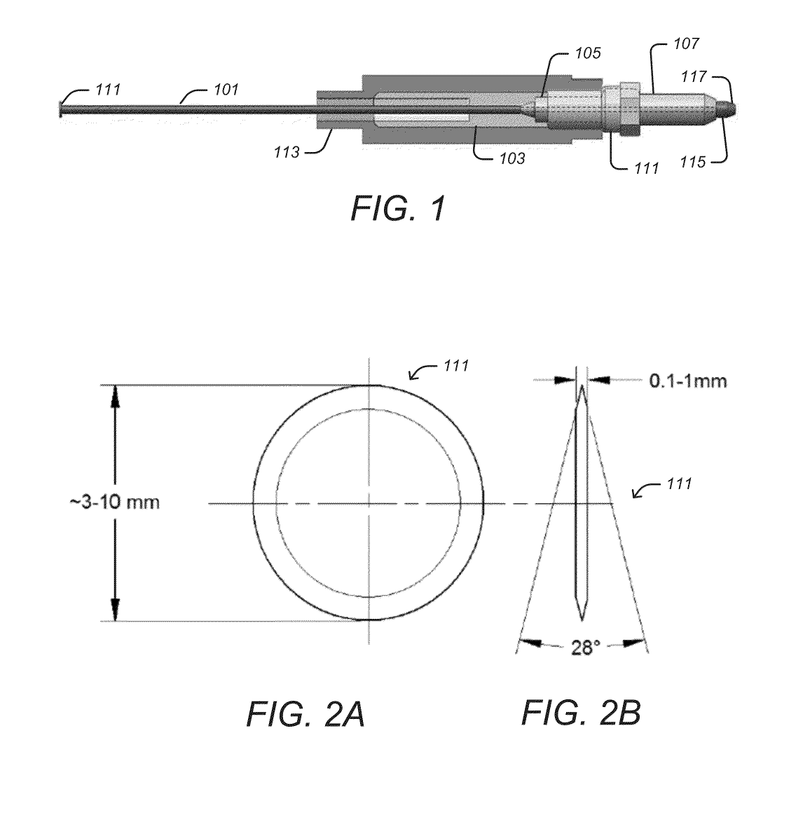

FIG. 1 illustrates an example of a transient plasma electrode apparatus. The apparatus may include an elongated electrode 101, insulation jackets 103, 105, and 107 which may be ceramic, an electric-field enhancing portion at one end which in this example may be a metallic disc 111 that is electrically connected and attached to the elongate electrode 101, a metallic shoulder 111 configured to be screwed or otherwise affixed to a spark plug opening in an engine, and a metal adapter 113. The other end 115 of the elongated electrode 101 may have a configuration that attached to a wire, such as a sparkplug wire, which may include an indented portion 117.

FIGS. 2A and 2B illustrate an enlarged front-facing and side view, respectively, of the metallic disc 111 that is part of the transient plasma electrode apparatus illustrated in FIG. 1.

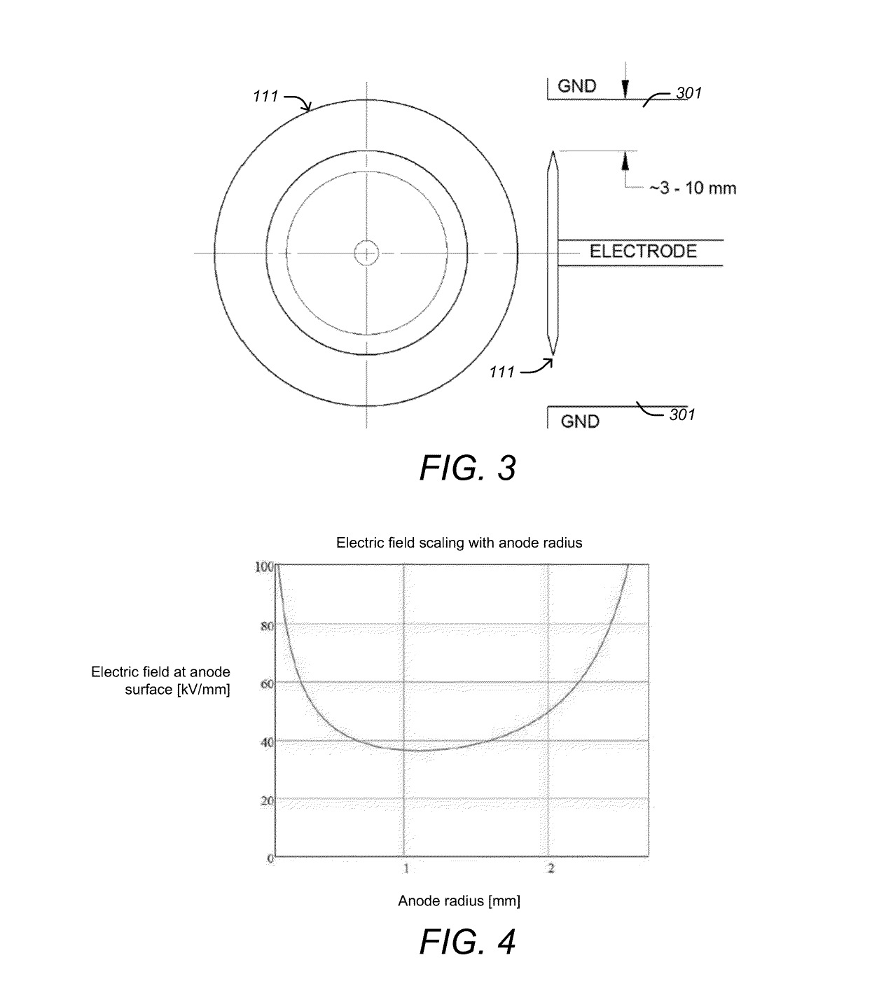

FIG. 3 illustrates an example of the metallic disc 111 that is part of the transient plasma electrode apparatus illustrated in FIG. 1 surrounded by a cylinder chamber 301 of an engine.

FIG. 4 is a graph showing a relationship between the radius of the anode metallic disc 111 shown in FIG. 1 and an electric field at its surface.

For a given channel diameter (or radius), an optimum size of the axial electrode diameter may be about 2.7 times smaller than the channel diameter. The elongated electrode 101 may be cylindrical with a diameter of between 0.2-0.6 or 0.33-0.4 times the diameter of a cylinder in which it may be placed and/or a diameter of 1.2-3.6 mm or 2-2.4 mm. This may minimize the electric field generated between the axial electrode and the channel wall. Compressed air in the cylinder may be used as a dielectric insulator between the axial electrode and the wall.

Arcing or breakdown may be eliminated or reduced in this region, provided the electrode voltage is kept below the atmospheric pressure breakdown strength of air (˜20 kV/cm) times the compression ratio (in this case CR ˜20), or ˜400 kV/cm. This may correspond to a maximum electrode voltage of 40 kV for the above channel size of 3 mm dia. For transient plasma generation with very short, 10-20 ns long pulses, the peak electrode voltage may be increased to ˜60 kV without arc formation. The metallic disc 111 may avoid plasma generation and arc formation in the glow-plug channel by the inclusion of a sharp edged perimeter, as illustrated in FIGS. 2A and 2B.

The sharp edge of the metallic disk 111 may ensure the generation of transient plasma at the desired position. In addition, if a commercial spark-plug is used as the pressure sealing part of the electrode assembly, a re-entrant ceramic insulator may be used to avoid electrical breakdown and arcing along the insulator surface. The re-entrant section of this insulator may ensure an electrical path-length at least twice the anode-cathode distance.

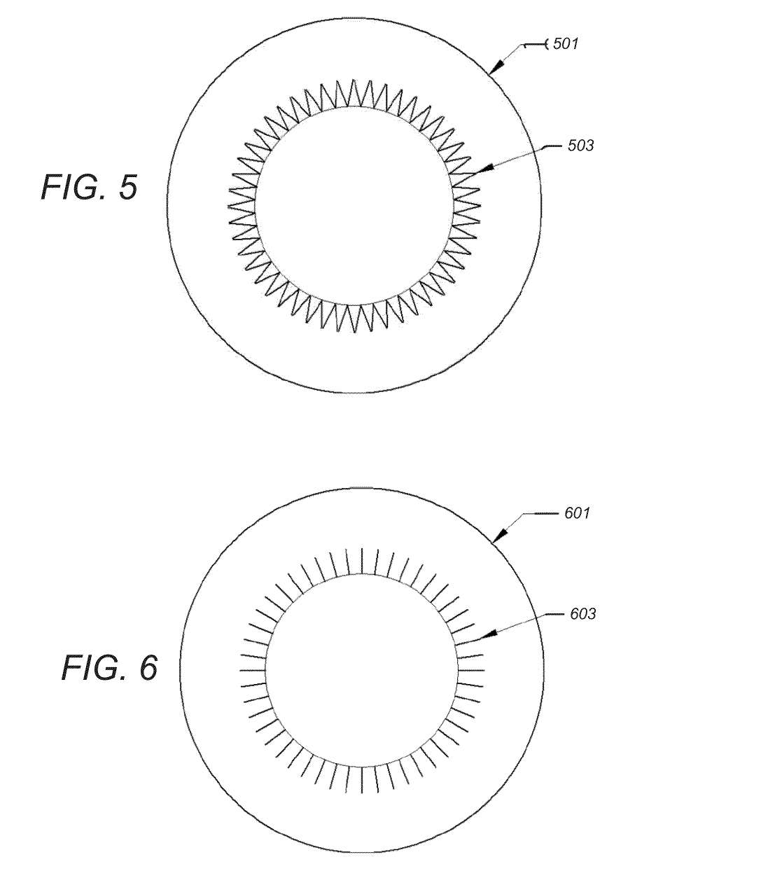

FIG. 5 illustrates an example of a metallic disc 501 with radially-extending sharp metallic tips 503 that may be used in lieu of the metallic disc illustrated in FIG. 1.

FIG. 6 illustrates an example of a metallic disc 601 with radially-extending sharp metallic wire tips 603 that may be used in lieu of the metallic disc illustrated in FIG. 1.

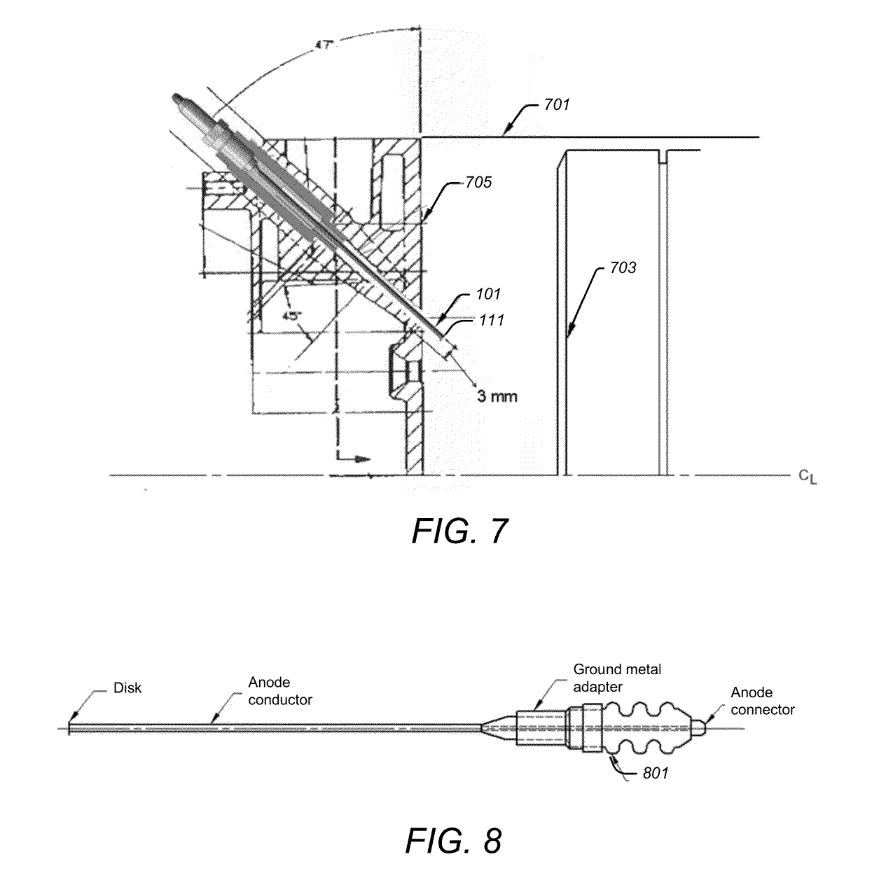

FIG. 7 illustrates the transient plasma electrode apparatus illustrated in FIG. 1 positioned within an example of a high compression engine. The compression engine may have an engine block 701, a piston 703, and an engine head 705.

FIG. 8 illustrates another example of a transient plasma electrode apparatus. It is similar to the one illustrated in FIG. 1, except that an insulator 801 may have a ribbed exterior.

By reducing possible breakdown along the electrode port and along solid insulator surfaces, this electrode design may achieve reliable and consistent transient plasma operation in diesel engines, even when utilizing existing glow-plug ports for electrode mounts.

The components, steps, features, objects, benefits, and advantages that have been discussed are merely illustrative. None of them, nor the discussions relating to them, are intended to limit the scope of protection in any way. Numerous other embodiments are also contemplated. These include embodiments that have fewer, additional, and/or different components, steps, features, objects, benefits, and advantages. These also include embodiments in which the components and/or steps are arranged and/or ordered differently.

Unless otherwise stated, all measurements, values, ratings, positions, magnitudes, sizes, and other specifications that are set forth in this specification, including in the claims that follow, are approximate, not exact. They are intended to have a reasonable range that is consistent with the functions to which they relate and with what is customary in the art to which they pertain.

All articles, patents, patent applications, and other publications that have been cited in this disclosure are incorporated herein by reference.

The phrase “means for” when used in a claim is intended to and should be interpreted to embrace the corresponding structures and materials that have been described and their equivalents. Similarly, the phrase “step for” when used in a claim is intended to and should be interpreted to embrace the corresponding acts that have been described and their equivalents. The absence of these phrases from a claim means that the claim is not intended to and should not be interpreted to be limited to these corresponding structures, materials, or acts, or to their equivalents.

The scope of protection is limited solely by the claims that now follow. That scope is intended and should be interpreted to be as broad as is consistent with the ordinary meaning of the language that is used in the claims when interpreted in light of this specification and the prosecution history that follows, except where specific meanings have been set forth, and to encompass all structural and functional equivalents.

Relational terms such as “first” and “second” and the like may be used solely to distinguish one entity or action from another, without necessarily requiring or implying any actual relationship or order between them. The terms “comprises,” “comprising,” and any other variation thereof when used in connection with a list of elements in the specification or claims are intended to indicate that the list is not exclusive and that other elements may be included. Similarly, an element preceded by an “a” or an “an” does not, without further constraints, preclude the existence of additional elements of the identical type.

None of the claims are intended to embrace subject matter that fails to satisfy the requirement of Sections 101, 102, or 103 of the Patent Act, nor should they be interpreted in such a way. Any unintended coverage of such subject matter is hereby disclaimed. Except as just stated in this paragraph, nothing that has been stated or illustrated is intended or should be interpreted to cause a dedication of any component, step, feature, object, benefit, advantage, or equivalent to the public, regardless of whether it is or is not recited in the claims.

The abstract is provided to help the reader quickly ascertain the nature of the technical disclosure. It is submitted with the understanding that it will not be used to interpret or limit the scope or meaning of the claims. In addition, various features in the foregoing detailed description are grouped together in various embodiments to streamline the disclosure. This method of disclosure should not be interpreted as requiring claimed embodiments to require more features than are expressly recited in each claim. Rather, as the following claims reflect, inventive subject matter lies in less than all features of a single disclosed embodiment. Thus, the following claims are hereby incorporated into the detailed description, with each claim standing on its own as separately claimed subject matter.

The invention claimed is:

1. A transient plasma electrode apparatus comprising:
an elongated electrode having a first and a second end, the first end having a configuration that connects to a source of high voltage pulses;
an insulation jacket surrounding a portion of the electrode; and
an electric-field enhancing protrusion at the second end of the elongated electrode that causes an electric field generated by the application of a high voltage between the elongated electrode and a metallic wall of a combustion chamber in which the electrode is placed to be greater at the second end as compared to along the length of the electrode.

2. The transient plasma electrode apparatus of claim 1 wherein the electric-field enhancing protrusion includes a disc.

3. The transient plasma electrode apparatus of claim 2 wherein the disc has a perimeter that forms a sharp edge.

4. The transient plasma electrode apparatus of claim 1 wherein the electric-field enhancing protrusion includes one or more spokes.

5. The transient plasma electrode apparatus of claim 4 wherein the electric-field enhancing protrusion includes multiple spokes.

6. The transient plasma electrode apparatus of claim 1 wherein the insulation jacket has external threads.

7. The transient plasma electrode apparatus of claim 1 wherein the transient plasma electrode apparatus is for inserting into a cylinder chamber of an engine having a chamber diameter and wherein the elongated electrode is cylindrical with an electrode diameter of between 0.2-0.6 times the cylinder diameter.

8. The transient plasma electrode apparatus of claim 7 wherein the elongated electrode has an electrode diameter of between 0.33-0.4 times the cylinder diameter.

9. The transient plasma electrode apparatus of claim 1 wherein the elongated electrode is cylindrical with an electrode diameter of between 1.2-3.6 mm.

10. The transient plasma electrode apparatus of claim 1 wherein the elongated electrode is cylindrical with an electrode diameter of between 2-2.4 mm.

11. The transient plasma electrode apparatus of claim 1 wherein the insulation jacket is made of a ceramic material.

12. The transient plasma electrode apparatus of claim 1 wherein the elongated electrode has a length of between 1-5 inches.

13. The transient plasma electrode apparatus of claim 12 wherein the elongated electrode has a length of between 1.5-3 inches.

14. The transient plasma electrode apparatus of claim 1 wherein the insulation jacket has ribs.

15. The transient plasma electrode apparatus of claim 1 wherein the first end has a configuration that attaches to a wire, the configuration including an indented portion.

16. The transient plasma electrode apparatus of claim 1 further comprising a second insulation jacket.

17. A high compression engine comprising:
a metallic, cylindrical combustion chamber;
a piston within the cylindrical combustion chamber; and
an elongated electrode having an end protruding within the cylindrical combustion chamber that does not have a ground portion affixed to its end and that has a configuration that causes arcing between the elongated electrode and the cylindrical combustion chamber upon application of high voltage potential between the elongated electrode and cylindrical combustion chamber.

18. The high compression engine of claim 17 wherein the cylindrical combustion chamber has a chamber diameter and the elongated electrode is cylindrical with a width of between 0.2-0.6 times the chamber diameter.

19. A high compression engine comprising:
a cylindrical combustion chamber;
a piston within the cylindrical combustion chamber; and
an elongated electrode protruding within the cylindrical combustion chamber, wherein the engine operates with a compression ratio within the cylindrical combustion chamber that exceeds 16.

20. The high compression engine of claim 19 wherein the cylindrical combustion chamber has a chamber diameter and the elongated electrode is cylindrical with a width of between 0.2-0.6 times the chamber diameter.
